(19) United States
(12) Patent Application Publication
(10) Pub. No.: US 2003/0211799 A1
(43) Pub. Date: Nov. 13, 2003

(54) Functional fibers and fibrous materials

(75) Inventors: Li Yao, Peachtree City, GA (US); Guoqiang Mao, Smyrna, GA (US); Xingguo Li, Peachtree City, GA (US)

Correspondence Address: PENNIE & EDMONDS LLP, 1667 K STREET NW, SUITE 1000, WASHINGTON, DC, 20006

(73) Assignee: Porex Corporation

(21) Appl. No.: 10/464,443

(22) Filed: Jun. 19, 2003

Related U.S. Application Data
(63) Continuation of application No. 09/838,200, filed on Apr. 20, 2001, now abandoned.

(51) Int. Cl. B32B 25/02; B32B 25/10; B32B 27/04; B32B 27/12; B32B 17/02; B32B 27/02; D04H 1/00; D04H 3/00; D04H 5/00; D04H 13/00; D04H 1/06; D04H 1/74; D04H 3/05

(52) U.S. Cl. 442/361; 442/362; 442/363; 442/364; 442/367; 442/360; 442/359; 442/331; 442/332; 442/333; 442/353; 428/296.7; 428/298.1; 428/299.4; 428/299.7; 428/300.4

(57) ABSTRACT

Fibers and fibrous materials are disclosed that comprise a functional fiber and a binder fiber. The functional fiber can be a continuous or a staple fiber, while the binder fiber is a staple bicomponent fiber. Uses of the fibers and fibrous materials are also disclosed.

### 1. FIELD OF THE INVENTION

The invention relates to fibers and fibrous materials and methods of making and using the same.

### 2. BACKGROUND OF THE INVENTION

Fibers and materials made from them (referred to herein as “fibrous materials”) have a variety of uses. Many fibrous materials are composites. For example, U.S. Pat. No. 4,270,962 discloses a method of manufacturing fused bundles of fibers. In this method, a bundle of low and high melting-point fibers is heated under pressure at a temperature that melts the low melting-point fibers, and then cooled to provide a bar-like material. See, e.g., col. 1, lines 26-61.

U.S. Pat. No. 4,795,668 discloses the manufacture of bicomponent fibers. These fibers are distinguishable from fused bundles of fibers in that each fiber consists of two components that “generally extend continuously along the fiber.” Col. 3, lines 38-41. Examples of bicomponent fibers contain a core surrounded by a sheath, wherein the core is made of a crystallizable material such as polyethylene terephthalate (PET), and the sheath is made of a thermosoftening material such as crystalline polypropylene or amorphous polystyrene. See, e.g., col. 3, lines 30-36; col. 4, lines 55-60. The bicomponent fibers can allegedly be incorporated into webs along with other fibers. See, e.g., col. 3, line 52 to col. 4, line 7.

U.S. Pat. No. 4,830,094 discloses a porous non-woven fabric made of multiple fibers that allegedly form a uniform web when heated together. See, col. 1, lines 42-48. The fabric is reportedly made by carding a bicomponent fiber to form a fibrous web, which is then heated to cause the fibers to bind to each other. See, col. 2, lines 17-24. The bicomponent fiber is made of components that have crystalline melting points which differ by at least 30° C., and which can allegedly be arranged in a variety of configurations. See col. 2, lines 65-67; col. 3, lines 29-33.

The fusing of commercially available core/sheath bicomponent fibers to provide a non-woven fabric is also disclosed by U.S. Pat. No. 5,284,704. The fabric can allegedly be used as drive belts and seals, nibs felts for marking pens, filter cloths for plate and frame filters, filtration cartridges, stamp pad ink reservoirs, and battery separators. Col. 2, lines 20-24.

The use of bicomponent fibers to provide materials allegedly useful as tobacco smoke filters is disclosed by U.S. Pat. Nos. 5,509,430; 5,607,766; 5,620,641; and 5,633,032. In each of these patents, a core/sheath bicomponent fiber is melt-blown and formed into a porous element using methods known in the art. See, e.g., U.S. Pat. No. 5,509,430 at col. 9, lines 38-58.

A final example of composite fibrous materials is provided by U.S. Pat. No. 5,948,529, which discloses bicomponent fibers having a core made of PET and functionalized ethylene copolymer, and a sheath made of polyethylene. See, e.g., col. 1, line 64 to col. 2, line 1. The functionalized copolymer allegedly helps the sheath adhere to the core. See, col. 2, lines 1-3.

Until now, the physical and chemical properties of fibers and fibrous materials could not be precisely tuned to particular applications. In part, this is due to manufacturers' desire to produce materials that have consistent properties (e.g., density) and because they are extruded from raw materials, continuous fibers provide that desired consistency. However, it is very difficult and expensive to make fibers comprised of more than one type of continuous fiber using that process. It is for this reason that fibers and fibrous materials used in many applications are a compromise between cost and commercial availability and the demands of those applications. A need therefore exists for fibers and fibrous materials that can be specifically tailored for use in a wide range of applications.

### 3. SUMMARY OF THE INVENTION

This invention is directed to fibers and materials made from them that can be used in a variety of applications such as, but not limited to, wicks and other elements designed to collect, hold, transfer or deliver liquids for medical and other applications (e.g., marker nibs, wicks used for chemical sample collection, storage, or analysis), lateral flow devices, self-sealing devices (e.g., self-sealing filters, and self-sealing pipette filters), selective absorptive devices (e.g., bio-liquid filtration, air and liquid separation/filtration filters, ion exchange filters), heat and moisture exchangers, and other diverse fibrous matrices, such as insulation, packing materials, and battery (cathode/anode) separators.

The invention is based, in part, on the discovery that staple fibers can be used to provide fibers and fibrous materials with specific and precisely tuned chemical and physical properties.

A first embodiment of the invention encompasses a fibrous material comprised of a binder fiber adhered to a functional fiber, wherein the binder fiber is a staple bicomponent fiber oriented in substantially the same direction as the functional fiber. The functional fiber can be a staple or continuous fiber.

Examples of suitable binder fibers include, but are not limited to, bicomponent fibers made of the following pairs of polymers: polypropylene/polyethylene terephthalate (PET); polyethylene/PET; polypropylene/Nylon-6; Nylon-6/PET; copolyester/PET; copolyester/Nylon-6; copolyester/Nylon-6,6; poly-4-methyl-1-pentene/ PET; poly-4-methyl-1-pentene/Nylon-6; poly-4-methyl-1-pentene/Nylon-6,6; PET/polyethylene naphthalate (PEN); Nylon-6,6/poly-1,4-cyclohexanedimethyl (PCT); polypropylene/polybutylene terephthalate (PBT); Nylon-6/co-polyamide; polylactic acid/polystyrene; polyurethane/acetal; and soluble copolyester/polyethylene.

Examples of functional fibers include, but are not limited to, Nylons, cellulose-based materials, polyvinyl alcohols (e.g., phosphorylated polyvinyl alcohol), superabsorbent fibers, carbon fibers, glass fibers, ceramic fibers, and acrylic fibers.

Preferred fibrous materials have a density of from about 0.15 g/cm³ to about 0.8 g/cm³, more preferably from about 0.2 g/cm³ to about 0.65 g/cm³, and most preferably from about 0.25 g/cm³ to about 0.5 g/cm³.

A second embodiment of the invention is a functional wicking material comprising a binder fiber adhered to a hydrophilic functional fiber, wherein the binder fiber is a staple bicomponent or monocomponent fiber oriented in substantially the same direction as the hydrophilic fiber. Examples of suitable bicomponent binder fibers include, but are not limited to, the binder pair materials listed in Table 1. Examples of monocomponent binder fibers include, but are not limited to, PE, PP, PS, nylon-6, nylon-6,6, nylon-12, copolyamides, PET, PBT, and CoPET. Preferred bicomponent binder fibers made of polyethylene/PET, polypropylene/PET, or CoPET/PET. The preferred monocomponent binder fibers are PE, PP, or PET. Examples of suitable hydrophilic functional fibers include, but are not limited to, high absorbent rayon, Lyocel or Tencel, hydrophilic nylon, hydrophilic acrylic fibers, and cellulosic based high absorbent fibers.

A preferred wicking material wicks water at a rate of from about 0.05 to about 1.0 inches/second at 1 inch wicking length, preferably from about 0.1 to about 0.6 inches/second, and most preferably from about 0.2 to about 0.4 inches/second.

Another preferred functional wicking material comprises from about 1 to about 98 weight percent, more preferably from about 5 to about 95 weight percent, and most preferably from about 5 to about 50 weight percent of binder fiber. Still another preferred wicking material comprises from about 5 to about 70, more preferably from about 5 to about 55, and most preferably from about 10 to about 40 weight percent of functional fiber.

A third embodiment of the invention is a functional self-sealing materail comprising a binder fiber adhered to a superabsorbent fiber, wherein the binder fiber is a staple bicomponent or monocomponent fiber oriented in substantially the same direction as the superabsorbent fiber. Examples of suitable bicomponent binder fibers include, but are not limited to, the pairs listed in Table 1. Examples of monocomponent binder fibers include, but are not limited to, PE, PP, PS, nylon-6, nylon-6,6, nylon-12, copolyamides, PET, PBT, and CoPET, or the mixtures thereof. The preferred bicomponent binder fibers are PE/PP, PE/PET, PP/PET, and CoPET/PET. The preferred monocomponent binder fibers are PE, PP, and PET. Examples of suitable superabsorbent fibers include, but are not limited to, cellulosic based fibers, hydrolyzed starch acrylonitrile graft copolymer; neutralized starch-acrylic acid graft copolymer; saponified acrylic acid ester-vinyl acetate copolymer; hydrolyzed acrylonitrile copolymer; acrylamide copolymer; modified crosslinked polyvinyl alcohol; neutralized self-crosslinking polyacrylic acid; crosslinked polyacrylate salts; neutralized crosslinked isobutylene-maleic anhydride copolymers; or salts or mixtures thereof.

A preferred functional self-sealing material comprises from about 30 to about 95 weight percent, more preferably from about 45 to about 95 weight percent, and most preferably from about 60 to about 90 weight percent binder fiber. Another preferred functional self-sealing material comprises from about 5 to about 70 weight percent, more preferably from about 5 to about 55 weight percent, and most preferably from about 10 to about 40 weight percent superabsorbent fiber.

A fourth embodiment of the invention is a functional bioabsorbent material comprising a binder fiber adhered to a bioabsorbent fiber, wherein the binder fiber is a staple bicomponent or monocomponent fiber oriented in substantially the same direction as the bioabsorbent fiber. Examples of suitable bicomponent binder fibers include, but are not limited to, the pairs listed in Table 1. Examples of monocomponent binder fibers include, but are not limited to, PE, PP, PS, nylon-6, nylon-6,6, nylon-12, copolyamides, PET, PBT, CoPET, or mixtures thereof The preferred bicomponent binder fibers are PE/PP, PE/PET, PP/PET, or CoPET/PET. The preferred monocomponent binder fibers are PE, PP, or PET. Examples of suitable bioabsorbent fibers include, but are not limited to, cellulose acetate, cellulosic based fibers, phosphorylated polyvinyl alcohol, glass fibers, ceramic fibers, hydrophilic nylon, alkylated nylon, CNBr modified cellulose fibers, ion exchange fiber, or mixtures thereof.

A preferred bioabsorbent material comprises from about 30 to about 95 weight percent, more preferably from about 45 to about 95 weight percent, and most preferably from about 60 to about 90 weight percent binder fiber. Another preferred bioabsorbent material comprises from about 5 to about 70 weight percent, more preferably from about 5 to about 55 weight percent, and most preferably from about 10 to about 40 weight percent bioabsorbent fiber.

A fifth embodiment of the invention is a functional selective absorption/filtration material comprising a binder fiber adhered to a functional fiber, wherein the binder fiber is a staple bicomponent or monocomponent fiber oriented in substantially the same direction as the bioabsorbent fiber. Examples of suitable bicomponent binder fibers include, but are not limited to, the pairs listed in Table 1. Examples of monocomponent binder fibers include, but are not limited to, PE, PP, PS, nylon-6, nylon-6,6, nylon-12, copolyamides, PET, PBT, and CoPET. The preferred bicomponent binder fibers are PE/PP, PE/PET, PP/PET, and CoPET/PET. The preferred monocomponent binder fibers are PE, PP, and PET. Examples of suitable functional fibers include, but are not limited to, phosphorylated polyvinyl alcohol, glass fibers, hydrophilic nylon, alkylated nylon, ion exchange fibers, and activated carbon fibers.

A preferred functional selective absorption/filtration media comprises from about 30 to about 95 weight percent, more preferably from about 45 to about 95 weight percent, and most preferably from about 60 to about 90 weight percent binder fiber. Another preferred functional selective absorption/filtration media comprises from about 5 to about 70 weight percent, more preferably from about 5 to about 55 weight percent, and most preferably from about 10 to about 40 weight percent bioabsorbent fiber.

3.1. Definitions

As used herein, unless otherwise specified, the term “fiber,” means as any thread-like object or structure with a high length-to-width ratio and with suitable characteristics for being processed into a fibrous materials. Fibers can be made of materials including, but not limited to, synthetic or natural materials.

As used herein, unless otherwise specified the term “staple fibers” means fibers cut to specific lengths.

As used herein, unless otherwise specified the term “bicomponent fiber” means a fiber combining segments of two differing compositions, generally side-by-side or one inside another (core and sheath).

As used herein, unless otherwise specified the term “functional fiber” means a fiber having a desired function.

As used herein, unless otherwise specified, the term “oriented in substantially the same direction” means that the longitudinal axes of less than about 35, more preferably less than about 15, and most preferably less than about 10 percent of the fibers referred to deviate from the mean longitudinal axis of the total fibers referred to by less than about 45, more preferably less than about 30, and most preferably less than about 15 degrees.

### 4. BRIEF DESCRIPTION OF THE DRAWINGS

Aspects of the invention can be understood with reference to the following drawings. It is to be understood, however, that the scope of this invention and various aspects of it are not limited by the figures, which are merely representative of a few of its embodiments:

FIG. 1 provides a representation of a core/sheath staple binder fiber and a cross-sectional view of the same;

FIG. 2 provides a representation of a side-by-side staple binder fiber and a cross-sectional view of the same;

FIG. 3 provides a representation of a fiber of the invention comprised of single-component continuous functional fibers adhered to core/sheath staple binder fibers and a cross-sectional view of the same;

FIG. 4 provides a representation of a fiber of the invention comprised of staple single-component functional fibers adhered to core/sheath staple binder fibers and a cross-sectional view of the same;

FIG. 5 provides a representation of a fiber of the invention comprised of continuous single-component functional fibers adhered to side-by-side staple binder fibers and a cross-sectional view of the same;

FIG. 6 provides a representation of a fiber of the invention comprised of staple single-component functional fibers adhered to side-by-side staple binder fibers and a cross-sectional view of the same;

FIG. 7 illustrates the effect of bulk density on water absorption;

FIG. 8 illustrates the effect of percent weight composition of functional fiber on water absorption in a wicking material;

FIG. 9 illustrates the effect of percent weight composition of functional fiber on water wicking rate; and

FIG. 10 compares the ink flow rate between several permanent marker nibs with felt nibs.

### 5. DETAILED DESCRIPTION OF THE INVENTION

This invention is based, in part, on the discovery that certain staple fibers (referred to herein as “binder fibers”) can be sintered with functional fibers to provide materials with a variety of desirable properties. Other fibrous materials used in this invention include, but are not limited to, staple or continuous functional fibers. Staple fibers are fibers cut to specific lengths. Binder fibers can be bicomponent fibers with a sheath having a low melting point and a core having a high melting point or can be monocomponent fibers having a lower melting point than other matrix fibers or web elements that are activated through the application of heat. Preferably, the present invention used bicomponent binder fibers.

Functional fibers can have any desired function. For example, the functional fiber component of a material can be useful for wicking aqueous-based solutions will be a fiber of a hydrophilic material. A functional fiber can also be a binder fiber, and a second or third staple mono-component or bicomponent fiber can be used as structural fiber to either reinforce the matrix or control pore size and porosity of the matrix. Other functional fibers include, but are not limited to: superabsorbent fibers, which can be used to provide self-sealing materials; bioabsorbent fibers, which can be used to provide materials useful in biomedical applications (e.g., sample collecting and testing); bioactive fibers, which can be used to provide biomolecule adsorption/binding function that are useful in biomedical applications (e.g., sample collecting and testing); and low adsorptive fibers, which can be used to reduce specific adsorption of biomolecules on the fiber surface. Functional fibers can be single or multi-component (e.g., bicomponent), and staple or continuous.

Because the ability of a particular fiber or fibrous material of the invention to perform a given function can be determined primarily or solely by the functional fiber(s) in it, this invention allows the unprecedented ability to design fibers and fibrous materials that are optimized for particular tasks.

For example, the wicking rate of a material of the invention can be controlled by the type(s) and relative amount(s) of hydrophilic/wicking functional fiber(s) in it. Similarly, if a material to be used as a biosensor must contain a specific amount or concentration of enzymes, this can be controlled by varying the type(s) and relative amount(s) of hydrophilic or chemically activated functional fiber(s) in it. Another example of uses of the materials of the invention include, but are not limited to, self-sealing pipette tips (i.e., pipette tips that allow the passage of air, but seal when contacted with an aqueous solution). The speed with which such pipette tips seal when contacted with water can be varied by adjusting the type(s) and amount(s) of functional fiber(s) (e.g., superabsorbent functional fibers) use therein. Other variations of this principle will be readily apparent to those skilled in the art.

Biomolecules, including, proteins, enzymes, nucleic acids, and cells can be immobilized onto different substrates by either physical adsorption or chemical covalent binding. They can be immobilized on different types of fiber materials through covalent binding or other interactions, including hydrophobic interaction, hydrogen bonds, or electrostatic interaction. There are wide varieties of chemistries available to immobilize biomolecules onto fiber materials. Many of these methods can be used to immobilize biomolecules onto the functional fiber materials disclosed herein. The materials of the invention also include materials that have controlled biomolecule adsorption ability for medical devices and diagnostic applications.

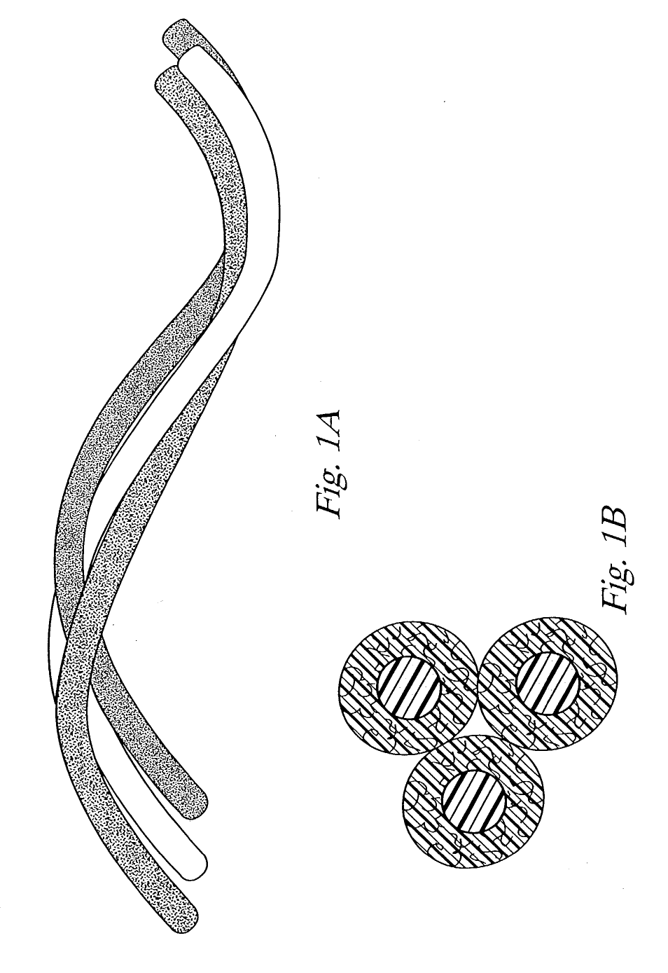

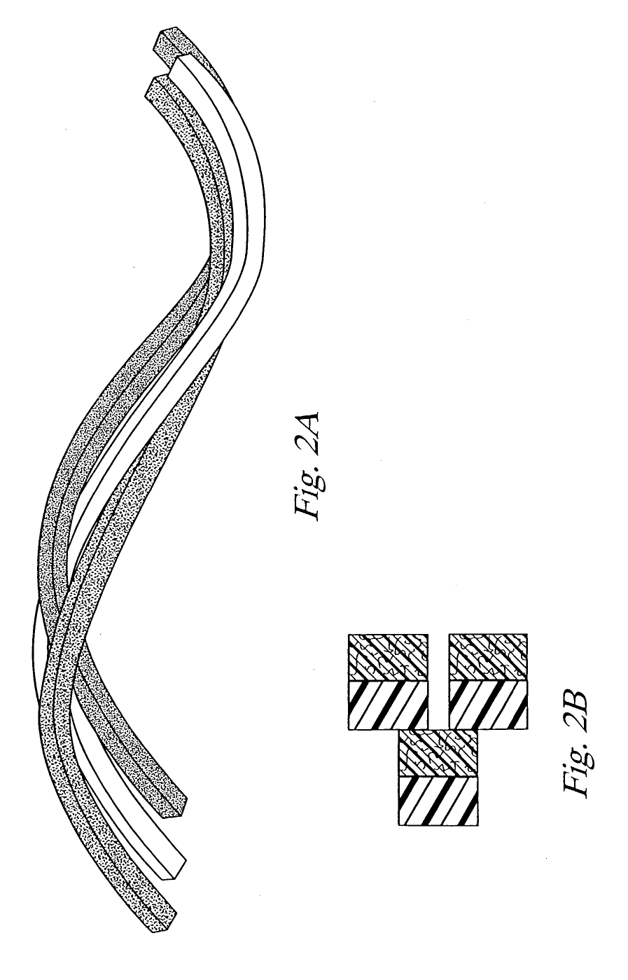

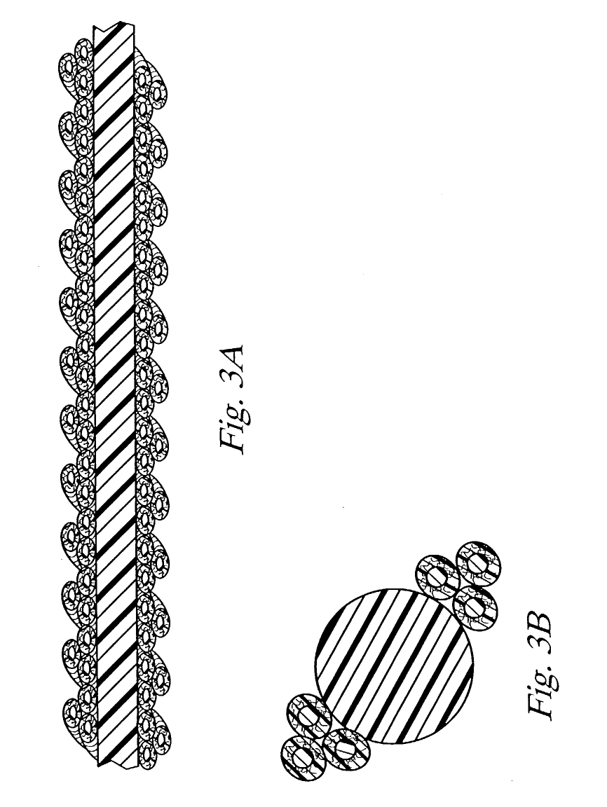

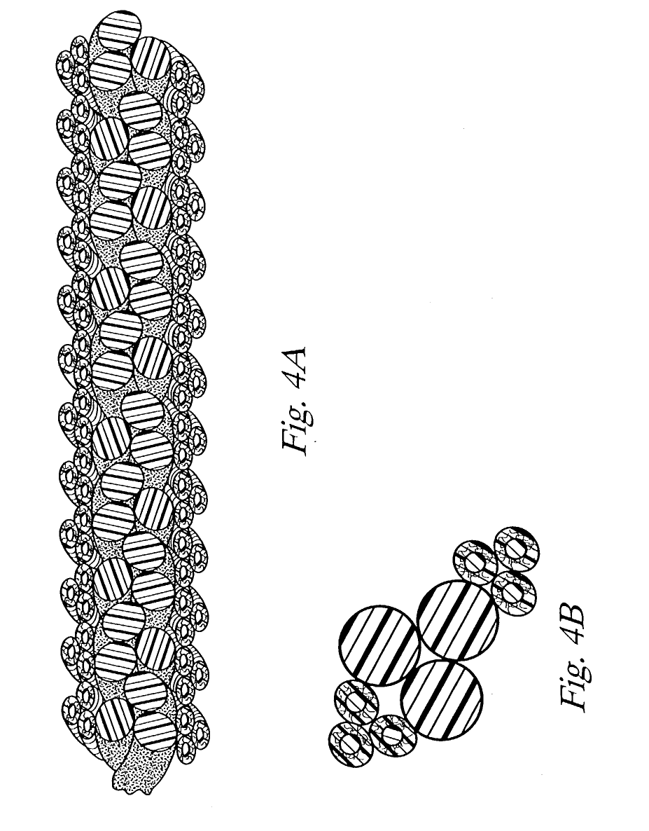

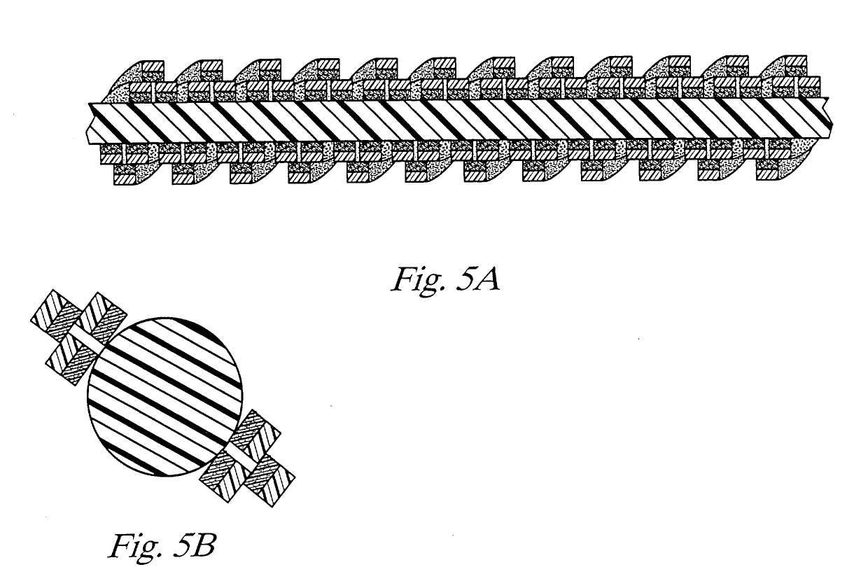

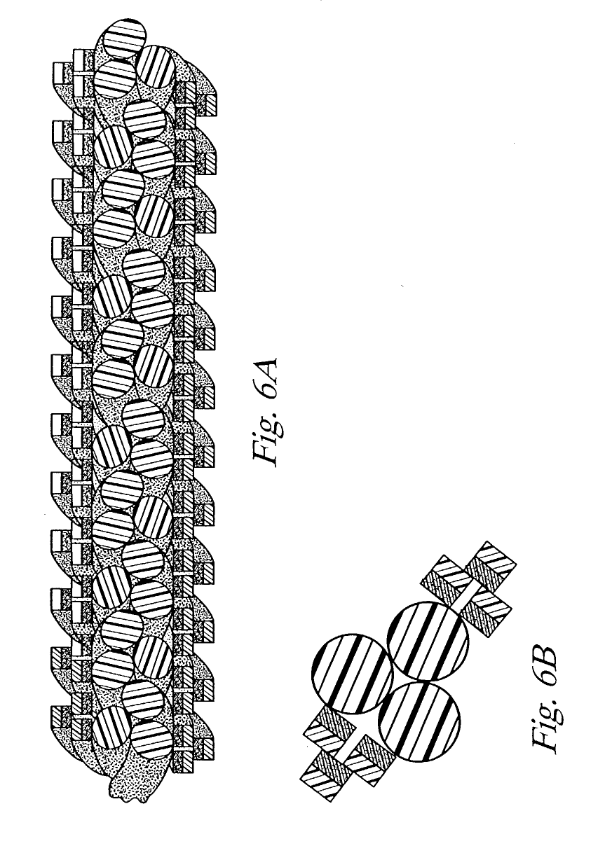

A general understanding of the structures of certain fibers and materials of the invention is aided by the attached figures. FIGS. 1 and 2 provide representations of core/sheath and side-by-side staple fibers that can be used as binder fibers. FIGS. 3 and 5 illustrate materials that comprise single-component continuous functional fibers adhered to core/sheath and side-by-side binder fibers, respectively. Materials of the invention that comprise staple single-component functional fibers are shown in FIGS. 4 and 6. Variations of each of these embodiments are described herein and will be readily apparent to those skilled in the art.

As shown in FIGS. 3 and 5, it is preferred that the binder and functional fiber components of a fiber of the invention are oriented in substantially the same direction. As described herein, binder and functional fibers can be oriented in substantially the same direction using techniques such as carding.

5.1. Components of Fibers and Fibrous Materials

5.1.1. Binder Fibers

The binder fibers used in the invention include bicomponent and monocomponent staple fiber. The cross-sectional structures of binder fibers that can be used in materials of the invention are preferably core/sheath and side-by-side, as shown in FIGS. 1 and 2, respectively. However, other cross-sectional structures known in the art can also be used. These include, but are not limited to, islands-in-the-sea, matrix fibril, citrus fibril, and segmented-pie cross-section types.

Bicomponent fibers used in the invention typically have a low-melting point component and a high-melting point component. Preferably, the low-melting point component melts at a temperature that will not disturb the crystallinity of the high-melting point component. More preferably, the low-melting point component melts at a temperature of about 30° C. lower than the melting temperature of the high-melting point component. A temperature difference of about 50° C. is even more preferred.

Examples of binder fibers include, but are not limited to, bicomponent fibers disclosed by U.S. Pat. Nos. 4,795,668; 4,830,094; 5,284,704.; 5,509,430; 5,607,766, 5,620,641; 5,633,032; and 5,948,529, each of which is incorporated herein by reference. Other examples include, but are not limited to, bicomponent fibers made of the following pairs of polymers: Nylon-6/PET; poly-4-methyl-1-pentene/ PET; poly-4-methyl-1-pentene/Nylon-6; poly-4-methyl-1-pentene/Nylon-6,6; Nylon-6/co-polyamide; polylactic acid/polystyrene; and soluble copolyester/polyethylene. Polyethylenes include, but are not limited to, high-density polyethylene (HDPE), low-density polyethylene (LDPE), and linear low-density polyethylene (LLDPE). Copolyesters include, but are not limited to, polyethylene isophthalate, PBT, and cis and trans poly-1,4-cyclohexylene-dimethylene terephthalate.

Examples of suitable binder fibers include, but are not limited to, bicomponent fibers made of the following pairs of polymers listed in Table 1.

TABLE 1
Bicomponent Binder Fiber Materials

| SHEATH | CORE |
|---|---|
| polyethylene (PE) | polypropylene (PP) |
| ethylene-vinyl acetate copolymer | polypropylene (PP) |
| (EVA) | |
| polyethylene (PE) | polyethylene terephthalate (PET) |
| polyethylene (PE) | polybutylene terephthalate (PBT) |
| Polypropylene (PP) | polyethylene terephthalate (PET) |
| Polypropylene (PP) | polybutylene terephthalate (PBT) |
| polyethylene (PE) | Nylon-6 |
| polyethylene (PE) | Nylon-6,6 |
| polypropylene (PP) | Nylon-6 |
| polypropylene (PP) | Nylon-6,6 |
| Nylon-6 | Nylon-6,6 |
| Nylon-12 | Nylon-6 |
| copolyester (CoPET) | polyethylene terephthalate (PET) |
| copolyester (CoPET) | Nylon-6 |
| copolyester (CoPET) | Nylon-6,6 |
| glycol-modified PET (PETG) | polyethylene terephthalate (PET) |
| polypropylene (PP) | poly-1,4-cyclohexanedimethyl (PCT) |
| polyethylene terephthalate (PET) | poly-1,4-cyclohexanedimethyl (PCT) |
| polyethylene terephthalate (PET) | polyethylene naphthalate (PEN) |
| Nylon-6,6 | poly-1,4-cyclohexanedimethyl (PCT) |
| polylactic acid (PLA) | polystyrene (PS) |
| polyurethane (PU) | acetal |

Examples of monocomponent binder fibers include, but are not limited to, polyethylene (PE), polypropylene (PP), polystyrene (PS), Nylon-6, Nylon-6,6, Nylon-12, copolyamides, polyethylene terephthalate (PET), polybutylene terephthalate (PBT), and copolyester (CoPET).

The size of staple fibers may be within a wide range, typically from about 0.5 dpf (denier per filament) to about 200 dpf, preferably, from about 1 dpf to about 20 dpf. More preferably, the size of staple fibers may be from about 1.5 dpf to about 10 dpf. Typically, the length of staple fibers is from about 0.5 inches to about 20 inches, preferably, from the length is from about 1 inch to about 5 inches. More preferably, the length of stable fibers is from about 1.5 inches to about 3 inches.

Preferably, fibrous materials typically have a bulk density from about 0.15 g/cm³ to about 0.8 g/cm³, more preferably from about 0.2 g/cm³ to about 0.65 g/cm³, and most preferably from about 0.25 g/cm³ to about 0.5 g/cm³ Staple bicomponent fibers suitable for use as binder fibers can be prepared by methods well known in the art. Copolymers of PET (CoPET) are prepared by copolymerizing other monomers, such as di-alcohols and di-carboxylic acids. The melting temperature of CoPET can be adjusted form about 100° C. to about 260° C., preferably, the melting temperature of CoPET is from about 110° C. to about 185° C.

Commercially available staple bicomponent fibers include, but are not limited to, T-201 (CoPET/PET), T-202 (CoPET/PET), T-230 (PP/PCT), T-253 (HDPE/PET), T-260 (PP/PET) and T-271 (Nylon-6/Nylon-6,6), manufactured by Fiber Innovation Technology Inc., Johnson City, Tenn., and KoSa 256 (PP/PET), manufactured by KoSa Co., Charlotte, N.C.

As described in more detail below, a preferred method of making fibers and fibrous materials of the invention comprises sintering a mixture of binder and functional fibers. Consequently, it is important that the binder fibers contain a component that is exposed to the functional fibers (e.g., the sheath of a core/sheath bicomponent fiber), and has a melting or sintering temperature lower than the temperature at which the functional fiber melts or decomposes. The functional fiber selected to provide a material with a desired property may therefore dictate what bicomponent fibers can be used as binder fibers.

5.1.2. Functional Fibers

The applications of the functional fibrous composites in the invention include, but are not limited to, wicking device, self-sealing device, selective adsorption, and low retention or low adsorption.

Wicking applications are based on the capillary function of functional fibers and binder fibers. Wicks functions include collection, storage, transfer or delivery of liquids. Wicking devices include, but are not limited to, writing instruments (e.g., permanent marker nibs, dry erase marker nibs, and highlight marker nibs), fragrance wicks, insecticide wicks, reservoirs for marker inks, and diagnostic devices (e.g., blood and other body fluid sample collection, storage, transfer, or analysis).

Self-sealing devices include, but are not limited to, self-sealing filters, self-sealing pipette filters, self-sealing valves, self-sealing dispensers, and self-sealing separators.

In the selective adsorption applications, functional fibers are selected to adsorb or filter biomolecules and other binding partners, usually through non-covalent or covalent interactions. Examples of biomolecules include, but are not limited to, biomolecules, such as proteins (e.g., antibody, antigen, enzyme), DNA/RNA, cells, etc. Examples of other binding partners include, but are not limited to, heavy ions, gas molecules, water, and oils. Applications of selective absorption devices include, but are not limited to, biomolecule (protein, DNA/RNA, cell, etc.) filtration, substrate for diagnostic devices, water purification, enzyme immobilization, oil/water separation, solid phase extraction for pre-chromatography treatment, and desiccants.

Examples of functional fibers include, but are not limited to, Nylons, cellulose-based materials, polyvinyl alcohols, superabsorbent fibers, carbon fibers, glass fibers, ceramic fibers, and acrylic fibers.

Because of their favorable hydrophilic microenvironments, Nylons can be particularly useful as functional fibers in applications wherein the immobilization of hydrophilic materials (e.g., bioactive agents such as drugs, oligonucleotides, polynucleotides, peptides, proteins, and cells) is desired. Other advantages of Nylons include high mechanical strength, superficial hardness, and resistance to abrasion. Examples of Nylons include, but are not limited to: Nylon-6; Nylon-9; Nylon-11; Nylon-12; Nylon-46; Nylon-46 monomer based; Nylon-6,6; Nylon-6,9; Nylon-6/66; Nylon-610; Nylon-612; and Nylon-6/T. If a Nylon is to be used for the immobilization of a bioactive agent, it is preferably pretreated to provide end-groups that are free for their attachment (e.g., via covalent bonds or ligand-receptor interactions). Suitable methods of pretreatment are known in the art and include, but are not limited to, hydrophilization. Methods for hydrophilization are known in the art and include, but are not limited to, copolymerization and surface treatment. Examples of hydrophilization of nylon from which functional hydrophilic nylon fibers can be made include, but are not limited to, those disclosed by U.S. Pat. Nos. 5,695,640, 5,643,662, 4,919,997, 4,923,454, 4,615,985, 3,970,597. Examples of hydrophilic nylons include, but are not limited to, StayGard®, manufactured by Honeywell International Inc., Hopewell, Va.

Alkylated nylon materials can be used to immobilize nucleic acids, e.g., DNA and RNA. One method of alkylating nylon is to treat nylon with an alkylating agent such as a trialkyloxonium salt under anhydrous conditions (See e.g. U.S. Pat. Nos. 4,806,546, 4,806,631). Active Nylon fiber is nylon that has been partially hydrolyzed, O-alkylated, N-alkylated, or altered during post-treatment such that fibers made from traditional nylons and binders is treated with O-alkylated reagent. Compared with traditional nylon, active nylons have more reactive functional groups, such as O-alkylated nylon, also called nylon imidoester, which can directly form covalent bonds with protein or can transferred to other reactive functional groups such as amino, thiol, and hydroxide. For example, proteins having lysine can be directly immobilized to O-alkylated nylon through the chemical reaction between the amino group in the protein and the oxygen in the O-alkylated nylon.

Cellulose-based materials can also be used to provide fibers and fibrous materials to which bioactive agents can be bound or trapped (e.g., via surface hydroxyl groups). One example of cellulose-based material is rayon, which is a regenerated cellulose fiber. In the production of rayon, purified cellulose is chemically converted into a soluble compound. A solution of this compound is passed through the spinneret to form soft filaments that are then converted or “regenerated” into cellulose. Rayon, especially high absorbent rayon, is a high water absorbent material. Examples of commercially available high absorbent rayon are Acordis Rayon-6140 and Rayon-6150, manufactured by Acordis Acordis Cellulosic Fibers Inc., Axis, Ala.

Rayon and other cellulose fiber materials can be activated to immobilize biomolecules. For example, the hydroxyl groups in rayon are activated by treating rayon with an alkaline solution, followed by reaction with cyanogen bromide, 1,1-carbonyldiimidazole (CDI), or p-toluenesulfonyl chloride (tosyl chloride). Another method to manufacture high protein binding cellulose fiber is post-treatment. In this method, the fibers are made from cellulose fiber and binder fibers, such as rayon, and subsequently treated with activation reagents, such as, CNBr, CDI or tosyl chloride.

Another cellulosic based functional fiber are Tencel or Lyocel. Tencel is a new form of cellulosic fiber, manufactured using an organic solvent spinning process without the formation of a derivative. For Tencel production, wood cellulose is dissolved directly in n-methyl morpholine n-oxide at high temperature and pressure. The cellulose precipitates in fiber form as the solvent is diluted. Subsequently, the fiber is purified and dried while the solvent is recovered and reused. Tencel has all the advantages of rayon, and in many respects is superior to rayon because of its high strength in both dry and wet states and high absorbency. In addition, the closed-loop manufacturing process used for Tencel is environmentally friendlier than that used to manufacture rayon. Examples of commercially available Tencel and Lyocel are Acordis Tencel®, manufactured by Acordis Acordis Cellulosic Fibers Inc., and Lyocel®, manufactured by Lenzing Aktiengesellschaft, A-4860 Lenzing, Austria.

Examples of suitable bioabsorbent fibers include, but are not limited to, cellulose acetate, cellulosic based fibers, phosphorylated polyvinyl alcohol, glass fibers, ceramic fibers, hydrophilic nylon, alkylated nylon, CNBr modified cellulose fibers, ion exchange fiber, or mixtures thereof. Absorbent fibers are made from materials including, but are not limited to, phosphorylated polyvinyl alcohol, glass fibers, hydrophilic nylon, alkylated nylon, ion exchange fibers, and activated carbon fibers.

Superabsorbent fibers are made from materials sometimes referred to as “superabsorptive polymers.” Such materials can absorb large amounts of water and retain their structural integrity when wet. See Tomoko Ichikawa and Toshinari Nakajima, “Superabsorptive Polymers,” Concise Polymeric Materials Encyclopedia, 1523-1524 (Joseph C. Salamone, ed.; CRC; 1999). Examples of superabsorbent materials from which functional fibers can be made include, but are not limited to, those disclosed by U.S. Pat. Nos. 5,998,032; 5,750,585; 5,175,046; 5,939,086; 5,836,929; 5,824,328; 5,797,347; 4,820,577; 4,724,114; and 4,443,515, each of which is incorporated herein by reference.

Specific superabsorbent fibers are made of hydrolyzed starch acrylonitrile graft copolymer; neutralized starch-acrylic acid graft copolymer; saponified acrylic acid ester-vinyl acetate copolymer; hydrolyzed acrylonitrile copolymer; acrylamide copolymer; modified cross-linked polyvinyl alcohol; neutralized self-crosslinking polyacrylic acid; crosslinked polyacrylate salts; neutralized crosslinked isobutylene-maleic anhydride copolymers; or salts or mixtures thereof. Particularly preferred superabsorbent fibers are made from sodium polyacrylic acid and the sodium salt of poly(2-propenamide-co-2-propenoic acid). Commercially available superabsorbent fibers include Camelot® 908 made from polyacrylic acid, and manufactured by Camelot Ltd., Canada, and Toyobo® N-38, made from cellulosic based rayon and manufactured by Toyobo Co. LTD., Osaka, 530-8230 Japan.

Carbon fibers can also be used in applications that require the immobilization of bioactive agents (e.g., enzymes), and can also be used to provide materials that are electrically conductive (e.g., for use as enzyme electrodes). Staple carbon fibers in particular have good mechanical strength, conductivity, and flexibility, and can be processed in a relatively easy manner. Carbon fibers can be used to passively adsorb biomolecules or they can be modified to covalently bond to biomolecules. Carbon fibers can be activated by reacting with oxide acid, such as nitric acid, or by treating a fiber made from carbon fiber and binder with activation reagents, such as nitric acid, after fiber formation. Activated carbon fibers can be used in air and water purification, recovery of organic compounds and solvents, deodorizing and decoloring, and ozone removal. Examples of commercially available activated carbon fibers (ACF) include, but are not limited to, Finegard® FED. CIR.-300-4, manufactured by Toho Carbon Fibers Inc., Japan, and rayon based ACF, manufactured by Carbon Resources Inc., Huntington Beach, Calif.

Enzymes and other bioactive agents can also be immobilized on glass and ceramic fibers, particularly those whose surfaces have been treated to provide readily accessible and/or reactive functional groups (e.g., hydroxyl, thiol, amine, carboxylic acid, and aldehyde groups). Particular advantages of these types of fibers is their resistance to microbial attack, high thermal stability, and high dimensional stability. Examples of glass and ceramic fibers that can be used as functional fibers include, but are not limited to, Chop Vantage® and Delta Chop®, manufactured by PPG Industries Inc., Pittsburgh, Pa. and H Filament-700, manufactured by Advanced Glass Yarns LLC, Aiken, S.C.

Other examples of functionalized binder fiber materials also include, glass fibers treated with organofunctional silanes, e.g. aminoalkyl-functional silanes.

Ion exchange fibers are used to develop cleaning systems for liquor waste and exhaust from nuclear power plants. Ion exchange fibers include, but are not limited to, strong acid based, weak acid based, strong base based, and weak base based. Examples of commercially available ion exchange fibers that can be used as functional fibers include, but are not limited to, Ionex® IEF-SC (strong acid), manufactured by Toray Industries Inc., Japan; Nitivy Ion Exchange Fiber (strong base), manufactured by Nitivy Inc., Japan; Fiban® K-I (strong base), Fiban® A-1 (weak acid), and Fiban® K-4 (weak base), and Fiban® AK-22 (has both anion and cation exchange capabilities), manufactured by Fiba Inc., Minsk, Belarus.

5.2. Manufacture of Fibers and Fibrous Materials

Fibers and fibrous materials of the invention can be readily made using techniques known in the art. In a preferred method, one or more types of functional fiber are selected based on the desired function of the final material. At least one binder fiber is selected that contains at least one component that will sinter at a temperature lower than the temperature at which the functional fiber(s) melt or decompose. The functional and binder fibers are then combined in a ratio determined by factors readily apparent to those skilled in the art. Such factors include, but are not limited to, the desired functionality of the final material, chemical stability, thermal stability, strength, flexibility, hardness, and other physical and chemical characteristics. However, the relative amount of binder fiber cannot be so little that the final material will not hold together under the conditions in which it is expected to be used.

Factors such as the desired mechanical strength of the final material will often dictate the ratio of binder fiber to functional fiber. For example, materials made with functional fibers that have little mechanical strength (e.g., cellulose-based fibers) will require a greater binder-to-functional fiber ratio than materials such as Nylon in order to provide a strong final material.

While the ratio of binder fiber(s) to functional fiber(s) will vary with the fibers used and the intended application of the final product, a typical material of the invention has from about 1 to about 98 weight percent, more preferably from about 5 to about 95 weight percent, and most preferably from about 5 to about 50 weight percent binder fiber, and from about 5 to about 70 weight percent, more preferably from about 5 to about 55 weight percent, and most preferably from about 10 to about 40 weight percent functional fiber.

The mixture of functional and binder fibers is blended and carded by a carder, such as those manufactured by J. D. Hollingsworth on Wheels, Inc., Greenville, S.C. Carding is a well-known technique, which aligns the fibers, and can be carried out using conventional carding equipment. A carder is a machine that combs or works fibers between the fine surfaces or points of a toothed surface in order to separate, clean, and align the fibers in a parallel orientation. Carding is the process that transforms entangled fiber mats into parallel fibrous slivers that are untwisted strand. Carding performs four major functions, a carder blends binder fibers and functional fibers, separates every fiber individually from the other fibers, arranges the fibers to a high degree of parallelization, and delivers the fiber to the outfeed in a consistently even manner. This last function is the most important step in the carding process. This is the point where the controllable linear density of the fiber stream is established.

The carded material is then heated in an oven, optionally under pressure, at a temperature sufficient to sinter the binder and functional fibers together, yet at a temperature insufficient to melt or damage the functional fibers. The mixture can either be heated in a mold or forced through a dye to achieve a product of a desired size, shape, and density. Once sintered, the product is cooled to provide the material of the invention.

Optionally, prior to sintering, additional materials can be added to the binder and functional fiber mixture. Additional materials include, but are not limited to, finishing agents and dyes. Examples of surface finishing agents include, but are not limited to, surfactants, lubricants, softeners, antistats, and other finishing agents, such as, antioxidants, antimicrobials. Surfactants and lubricants, which can be added to facilitate the extrusion of sintered mixtures, are well known in the art and include, but are not limited to, Tween-20® and Afilan® (fatty acid polyglycol ester). The relative amounts of these materials will be readily apparent to those skilled in the art, but typically range from about 0.005 to about 1 weight percent, more preferably from about 0.01 to about 0.75 weight percent, and most preferably from about 0.015 to about 0.5 weight percent of the mixture prior to sintering.

The sintered material can be further processed in a variety of ways. For example, the material can be cut, molded, or polished. If the material is a fiber (e.g., it was made by extruding the heated mixture of binder and functional fibers through a mold), it can be woven or heated to provide woven and non-woven fabrics. Further processing can also involve the immobilization of bioactive agents (e.g., drugs, peptides, proteins, or cells) onto the functional fiber portions of the final material. In some cases, the product may need to be processed to provide functional groups to which the bioactive agents can be bound.

The manufacture of some specific materials of the invention is described in further detail in the following non-limiting examples.

### 6. EXAMPLES

### 6.1. Example 1

Wicking Device for Water

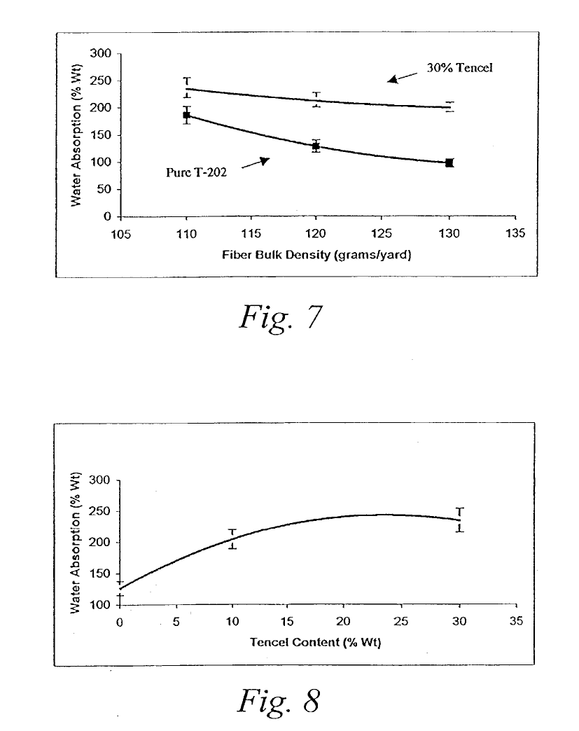

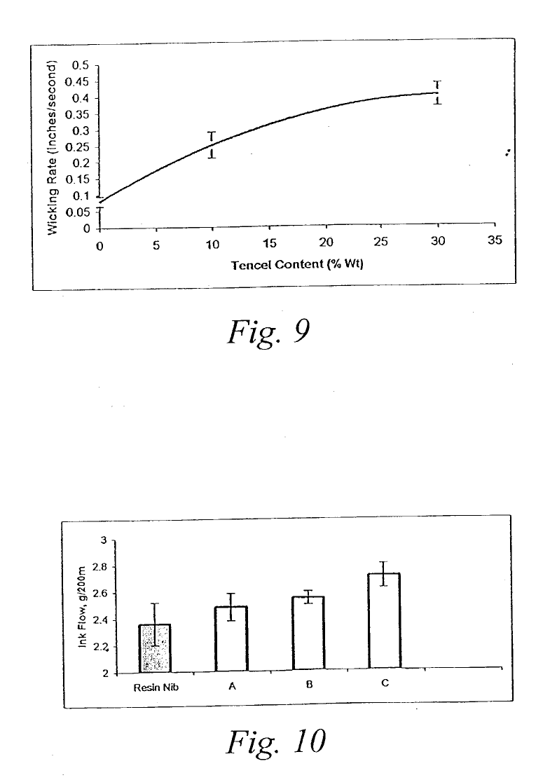

The fiber material comprised T-202 (CoPET/PET, weight ratio was about 50 to 50) staple fiber, manufactured by Fiber Innovation Technology Inc, Johnson City, Tenn., and Tencel®, manufactured by Acordis Cellulosic Fibers Inc, Axis, Ala. The staple fiber diameter of T-202 was 3 dpf and length was 1.5 inches. The staple fiber diameter of Tencel® was 3 dpf, and length was 1.5 inches. The material was blended and carded in John D. Hollingsworth on Wheels, Inc., Greenville, S.C. Three tests were carried out. For each formulation, three slivers (bundles) of fiber material with total size of 110, 120 and 130 g/yard, respectively, were introduced into the heating zone of an oven. Oven was 70 inches in length, 9.5 inches in width, and 15 inches in depth. The oven processing temperature was 200° C., the die control temperature was 90° C., and the pulling rate was 4 inches/min. The resulting functional fibrous material was shaped into a rectangular rod by pulling it through a die, and then the fibrous rod was introduced into a cooling zone where the rod was cooled by directing compressed cooling air. The comparison of the water absorption and water wicking rate properties of the functionalized formulations of (T-202/Tencel® blended fibers) with pure T-202 are illustrated in FIGS. 7, 8, and 9.

Given a specific fiber bulk density, the water absorption for the composites with Tencel® content was much higher than that of pure T-202. Tencel® is a cellulosic based fiber, which is a high water absorbent, and therefore functions as a high water absorption component in the composites. The amount of water absorption can be controlled by changing fiber bulk density. As shown in FIG. 7, the water absorption decreased as the bulk density increased. The water absorption can also be controlled by changing the fiber formulation. As shown in FIG. 8, as the Tencel® content changed from 0 to 30 weight percent, the water absorption doubled from 120% to 250 weight percent of fiber component.

The capillary force between water and fiber components affect the water wicking rate of fiber composites. The hydrophilic feature of cellulosic based fibers attributed a very good water wicking property to the fiber composites. As shown in FIG. 8, the higher the Tencel® content, the higher the water wicking rate. In summary, by changing the density and fiber formulation, both water absorption and water wicking property were controlled.

### 6.2. Example 2

Wicking Device for Ink

The binder fiber was T-202 with 3 dpf in size and 1.5 inches in length. The functional fibers were Tencel® and rayon-6150, respectively. The permanent marker nib formulation was pure T-202, and there were two formulations for dry erase marker nibs, Tencelo /T-202 and rayon-6150/T-202. The oven processing temperature was 210° C., the die control temperature was 100° C., and the pulling rate was 4 inches/minute. The die cross section was 3.7 mm in height and 5.7 mm in width. The cooled composites rectangular rods were cut into wedge shaped marker nibs of 40 mm in length.

An alcohol based dry erase marker ink was used to test the fiber composite ink wicking property. The test writing machine was made by Hutt, Germany. The machine was designed for pen writing on test paper. When the dry erase marker nibs were tested, the machine was modified by replacing writing paper with whiteboard covering with a non-osmotic smooth writing surface. The markers were fixed on the holders of the test writing machine at 60°, and the load applied on every marker was 120 g. The feed speed of test paper or test covering was 450 mm/min, and the writing-out speed was 4.5 m/min. The weight of each marker was measured at the initial, and every 50 m after writing test. FIG. 10 illustrates a comparison of the ink flow of permanent marker nibs with felt nibs with compositions as described in Table 2.

TABLE 2
Nib Material

| Group | Material |
|---|---|
| A | 30% Tencel ®, 70% T-202 |
| B | 10% Tencel ®, 70% T-202 |
| C | 10% Rayon, 70% T-202 |

The dry erase marker ink was a suspension comprising insoluble pigments and liquid vehicle. The capillary force, average pore size and porosity of fiber nibs determined the ink wicking property and ink flow. Good capillary force between the liquid vehicle and fibrous materials ensured a high ink flow. Sufficiently large pore size and suitable porosity were critical to allow ink pigment flow through. As shown in FIG. 10, all three formulations of sample A, B and C had higher ink flow, which can be attributed to the high hydrophilictiy and high capillary force of the additive fibers.

### 6.3. Example 3

Activated Nylon for Biomolecule Immobilization

Staple nylon fiber was mixed with staple binder fiber, and the mixture was carded into slivers. Fiber slivers were sintered in a heated oven to make fibrous rods. The sintered fibrous rods were cut into suitably sized samples, and then nylon fiber component in the samples was activated by alkylating reagent. The alkylated nylon components were used to immobilize protein, or modified by subsequent chemical methods, such as thiol functionalization, hydrazine functionalization, and aldehyde functionalization agents.

6.3.1. Fiber Component Sintering

The mixture of fibers comprised 30 percent by weight of staple bicomponent nylon-6/nylon-6,6, T-270, with size of 3 dpf, and length of 1.5 inches, and 70 percent of staple binder fiber, CoPET/PET, T-202, with size of 3 dpf, and length of 1.5 inches, both manufactured by Fiber Innovation Technology, Inc. The material was mixed and carded in John D. Hollingsworth on Wheels, Inc. The total size of fiber slivers were 110 grams/yard. The oven processing temperature was 190° C., the die control temperature was 90° C., and the pulling rate was 4 inches/minute. The resulting functional fibrous material was shaped into rectangular rods by pulling it through a die with 3.5 mm in width, and 9.5 mm in length.

6.3.2. Nylon Fiber Component Activation—Post-treatment

1). O-alkylated Functionalization

The sintered fibrous rods were cut into samples with dimension of 5.0×5.0×0.5 mm. 5 pieces of the samples were added into a screw-capped test tube. Subsequently to each was added an alkylation reagent and dimethyl sulfate. Each samples was covered in a closed test tube, and immediately immersed into boiling water bath for 4 minutes without stirring and submerged into an ice bath to stop the reaction. Excess dimethyl sulfate was removed on a suction filter and the alkylated nylon was washed several times with ice-cold methanol. The activated samples were immediately used for the enzyme attachment or subsequent chemical modification.

2). Thiol Functionalization

Into a screw-capped test tube containing the five pieces of O-alkylated nylon fiber component, was added 10 ml 0.5 M mecarptoethylamine aqueous solution, and the mixture was shaken for 30 minutes at room temperature. The excess reagents were separated by vacuum filtration and the modified nylon matrices were rinsed with five portions of PBS buffer solution (0.01 M, pH 7.2).

3). Hydrazine Functionalization

Into a screw-capped test tube containing the five pieces of O-alkylated nylon fiber component, was added 10 ml 0.5 M dihydrazine aqueous solution, and the mixture was shaken for 30 minutes at room temperature. The excess reagents were separated by vacuum filtration and the modified nylon matrices were rinsed with five portions of PBS buffer solution(0.01 M, pH 7.2).

4). Aldehyde Functionalization

Into a screw-capped test tube containing the five pieces of O-alkylated nylon fiber component, was added 10 ml 0.5 M ethylenediamine solution, and the mixture was shaken for 30 minutes at room temperature. The excess reagents were separated by vacuum filtration and the modified nylon matrices were rinsed with five portions of PBS buffer solution (0.01 M, pH 7.2).

Into a screw-capped test tube containing the five pieces of amino functionalized nylon fiber component, was added 10% glutaric dialdehyde aqueous solution, and the mixture was shaken for 30 minutes at room temperature. The excess reagents were separated by vacuum filtration and the modified nylon matrices were rinsed with five portions of PBS buffer solution (0.01 M, pH 7.2).

6.3.3. Protein Immobilization and Quantitative Detection

An enzymatic amplification method was developed to detect immobilized biomolecule on the nylon fiber component. The enzymatic amplification method was based on immobilization of bioactive enzyme onto the fiber. The immobilized enzyme can quantitative carry out specific chemical reactions and the product of these specific chemical reactions has a special physical property that can be detected with unaided human eye or a instrument, such as UV-VIS, such as horseradish peroxidase (HRP) labeled protein. By optimizing the chemical composition, a linear relationship between the enzyme quantity and the intensity of color absorption at wavelength 450 nm can be set up. Immobilized protein amount can be determined through the comparison between the sample and the standard curve.

1). Protein Immobilization

A protein solution at 1 mg/ml in a PBS buffer (0.01 m, pH 7.2) was added to the treated fiber. After 30 minutes, the nylon fiber component was washed with deionized water and dried at room temperature.

2). Quantitative Determination of Immobilized Protein

The following were the procedures used to quantitatively determine IgG binding on activated nylon fibrous matrices. Two pieces of test samples were placed into 1.5 ml centrifuge PE tubes (VWR) and 0.5 ml 1 μg/ml IgG-HRP, 1 mg/ml IgG deionized water solution was added to each test tube. The test tubes were shaken on a vibrator for two hours at room temperature. The samples were removed from the test tubes and dried using a KimWipe®. The test pieces were washed with three portions of 1 ml deionized water and the dried pieces were placed into dry 1.5 ml centrifuge tubes. 1 ml TMB Turbo solution (Pierces) was added to each tube, and each tube was incubated at room temperature for 15 minutes. The reaction was terminated by adding 0.5 ml of 2M HCl, the solution was transferred to a 1.5 ml UV cuvette, and the UV absorption was measured at the wavelength of 450 nm.

The embodiments of the invention described above are intended to be merely exemplary, and those skilled in the art will recognize, or will be able to ascertain using routine experimentation, numerous equivalents of the specific materials, procedures, and devices described herein. All such equivalents are considered to be within the scope of the invention and are encompassed by the appended claims.

What is claimed is:

1. A fibrous material comprised of a binder fiber adhered to a functional fiber, wherein the binder fiber is a staple bicomponent fiber oriented in substantially the same direction as the functional fiber.

2. The material according to claim 1, wherein the functional fiber is a staple or continuous fiber.

3. The material according to claim 1, wherein the binder fiber is a bicomponent fiber made of the following pairs of polymers: polypropylene/polyethylene terephthalate (PET); polyethylene/PET; polypropylene/Nylon-6; Nylon-6/PET; copolyester/PET; copolyester/Nylon-6; copolyester/Nylon-6,6; poly-4-methyl-1-pentene/PET; poly-4-methyl-1-pentene/Nylon-6; poly-4-methyl-1-pentene/Nylon-6,6; PET/polyethylene naphthalate (PEN); Nylon-6,6/poly-1,4-cyclohexanedimethyl (PCT); polypropylene/polybutylene terephthalate (PBT); Nylon-6/co-polyamide; polylactic acid/polystyrene; polyurethane/acetal; or soluble copolyester/polyethylene.

4. The material according to claim 1, wherein the functional fiber is a Nylon, cellulose-based material, polyvinyl alcohol, superabsorbent fiber, carbon fiber, glass fiber, ceramic fiber, or acrylic fiber.

5. The material according to claim 1, wherein said material has a density of from about 0.15 g/cm³ to about 0.8 g/cm³.

6. The material according to claim 5, wherein the density is from about 0.2 g/cm³ to about 0.65 g/cm³.

7. The material according to claim 6, wherein the density is from about 0.25 g/cm³ to about 0.5 g/cm³.

8. A wicking material comprising a binder fiber adhered to a hydrophillic functional fiber, wherein the binder fiber is a staple monocomponent or bicomponent fiber oriented in substantially the same direction as the functional fiber.

9. The material according to claim 8, wherein the binder fiber is a polyethylene/PET, polypropylene/PET, or coPET/PET bicomponent fiber.

10. The material according to claim 8, wherein the material wicks water at a rate of from about 0.05 to about 1 inch/second.

11. The material according to claim 10, wherein the rate is from about 0.1 to about 0.6 inch/second.

12. The material according to claim 11, wherein the rate is from about 0.2 to about 0.4 inch/second.

13. The material according to claim 8, wherein said material comprises from about 1 to about 98 weight percent binder fiber.

14. The material according to claim 13, wherein the material comprises from about 5 to about 95 weight percent binder fiber.

15. The material according to claim 14, wherein the material comprises from about 5 to about 50 weight percent binder fiber.

16. The material according to claim 8, wherein said material comprises from about 5 to about 70 weight percent functional fiber.

17. The material according to claim 16, wherein the material comprises from about 5 to about 55 weight percent functional fiber.

18. The material according to claim 17, wherein the material comprises from about 10 to about 40 weight percent functional fiber.

19. A self-sealing material comprising a binder fiber adhered to a superabsorbent fiber, wherein the binder fiber is a staple monocomponent or bicomponent fiber oriented in substantially the same direction as the superabsorbent fiber.

20. The material according to claim 19, wherein the bicomponent binder fiber is polyethylene/PET, polypropylene/PET, or coPET/PET.

21. The material according to claim 19, wherein the superabsorbent fiber is polyacrylic acid.

22. The material according to claim 19, wherein said material comprises from about 30 to about 95 weight percent binder fiber.

23. The material according to claim 22, wherein the material comprises from about 45 to about 95 weight percent binder fiber.

24. The material according to claim 23, wherein the material comprises from about 60 to about 90 weight percent binder fiber.

25. The material according to claim 19, wherein the material comprises from about 5 to about 70 weight percent functional fiber.

26. The material according to claim 25, wherein the material comprises from about 5 to about 55 weight percent functional fiber.

27. The material according to claim 26, wherein the material comprises from about 10 to about 40 weight percent functional fiber.

28. A bioabsorbent material comprised of a binder fiber adhered to a bioabsorbent fiber, wherein the binder fiber is a staple monocomponent or bicomponent fiber oriented in substantially the same direction as the bioabsorbent fiber.

29. The material according to claim 28, wherein the binder fiber is PE/PP polyethylene/PET, polypropylene/PET, or coPET/PET bicomponent fiber.

30. The material according to claim 28 wherein the bioabsorbent fiber is glass fiber, ceramic fiber, or hydrophilic Nylon.

31. The material according to claim 28, wherein said material comprises from about 30 to about 95 weight percent binder fiber.

32. The material according to claim 31, wherein the material comprises from about 45 to about 95 weight percent binder fiber.

33. The material according to claim 32, wherein the material comprises from about 60 to about 90 weight percent binder fiber.

34. The material according to claim 28, wherein the material comprises from about 5 to about 70 weight percent functional fiber.

35. The material according to claim 34, wherein the material comprises from about 5 to about 55 weight percent functional fiber.

36. The material according to claim 35, wherein said material comprises from about 10 to about 40 weight percent functional fiber.
